(19) United States
(12) Patent Application Publication
(10) Pub. No.: US 2010/0276402 A1
(43) Pub. Date: Nov. 4, 2010

(54) WELDING METHOD COMBINING A LASER BEAM AND THE ELECTRIC ARC WITH A CONSUMABLE ELECTRODE FOR ASSEMBLING ABUTTING METAL CONDUITS TO FORM PIPELINE METAL PIPES

(76) Inventors: Gilles Richard, Silly Le Long (FR); Abdelkrim Chehaibou, Metz (FR)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 11/916,281

(22) PCT Filed: Jun. 2, 2006
(86) PCT No.: PCT/FR06/01258

§ 371 Date: Jun. 21, 2010

(30) Foreign Application Priority Data
Jun. 2, 2005 (FR) 0505605

(51) Int. Cl. B23K 26/00

(52) U.S. Cl. 219/121.64; 219/121.63

(57) ABSTRACT

The invention concerns a welding device and a welding method, in particular of tubular parts (c1, c2) such as abutting metal conduits to form pipeline metal pipes, which consists in effecting the penetrating pass from outside. The invention is characterized in that it consists in creating a single liquid weld metal under the simultaneous action of at least one laser beam (1) transmitted by optical fiber and at least one electric arc protected by gas generated from a consumable electrode (2a) constituting the filler material. The invention is mainly applicable to the construction of pipelines.

This invention concerns a welding process, particularly for tubular parts such as metal conduits that are abutted to form pipeline type metal pipes, designed to convey oil and gas.

In order to form pipeline type pipes, it is important for the welding carried out between two conduits to have the qualities required for conveying materials such as oil and gas, the welding therefore avoiding the risk of weakness defects.

To make the weld joint reliably, a laser welding process has been proposed. However, the different laser welding processes and devices for their use present numerous problems.

Thus, according to EP 706,849 the laser source is distant from the focusing device and it is necessary to provide numerous sets of mirrors in order to turn the laser beam or beams around the circumference to be welded, thereby leading to a complex structure, necessitating meticulous and precise adjustment, which is unreliable and often entails a problem of heating of the mirrors. Furthermore, the laser welding device is positioned inside the conduits, which implies complex and expensive specific equipment difficult to maintain.

In document FR 2,812,227 a laser welding device is proposed, the electric power generating set of which is carried by an outside vehicle, the laser beam being placed orbitally and having a very high power exceeding 4 kW. Such a device therefore necessitates considerable power, which is not economically viable.

It has also been observed that, when the laser is used alone for welding, there is very low tolerance for squeeze conditions, notably when the presence of play is encountered. Furthermore, there being little or no filler metal present, the result is a very great dependence on the base metal compositions of the conduits to be welded, as far as the mechanical characteristics of the welding obtained are concerned. It is, in fact, not possible to improve those mechanical characteristics by working on the chemical composition of the filler metal and on the rate of feed of that filler metal (rate of deposit), which results in a reduction of hardness and increase of tenacity.

In document EP 0 852 984 a combined arc and laser welding process is proposed. In particular, arc welding is proposed first inside the conduits, followed by laser welding on the outside, or else laser welding first on the outside followed by arc welding inside. The process proposed therefore necessitates the use of two independent welding devices, one inside and the other outside, which entails a very high cost.

Document WO2005/056230, published after the priority date of this application and before its filing date, describes a laser welding method in which an MSG electric arc welding head is combined with the laser welding head. That electric arc welding head can be guided to act with the laser head in the laser welding zone or else be guided to follow the laser head. However, the device for use of that welding method does not provide, on the penetrating pass, the capacity to adjust independently of each other the position of the focus point of the laser beam, and the gap between the focus point of the laser beam and the position of the point of impact of the electric arc, as well as the angular position of the MIG welding torch relative to the laser beam.

A hybrid laser welding process is known according to FR 2,832,337. It is mentioned that the laser beam focuses on a portion of the parts consisting of a molten metal bath and that the electric arc is formed between the consumable electrode and the part to be welded at the molten metal bath, both the laser and MIG welding means converging toward a same molten metal bath. However, the melting bath is first created by fusion of the part to be welded in the standard way by the electric arc. A method of that type is also described in JP 2003205378.

Likewise, DE 198 49 117 provides for a laser welding process with two MIG processes making possible welding on very wide joints. The possibility of independently adjusting the welding devices, while remaining in a known operating system, is described there, as mentioned above.

In DE 103 04 709 a hybrid laser welding process using a welding head carrying a laser beam and electric arc welding means is described. The laser beam and the electric arc act in the same welding zone, the arc welding head, however, being positioned in front of the laser beam in the pass direction; it, therefore, acts first, creating the melting bath on which it then acts.

In other respects, none of the processes and devices described above makes it possible at the present time to adjust parameters such as the MIG electrode wire end position in relation to the focus point of the laser beam or angular position of the MIG torch in relation to the laser beam in the course of a welding cycle, the adjustment being possible only outside the welding operation.

The invention is intended to overcome those difficulties by proposing a new welding process in which the laser welding power for the penetrating pass is combined with that of the electric arc welding by consumable electrode, said process having a greatly improved welding speed, while using a lower laser power and presenting a relatively simple structure.

For that purpose, the object of the invention is a welding process, particularly for tubular parts, such as metal conduits that are abutted in order to form pipeline type metal pipes, in which the penetrating pass is made on the outside, characterized in that a single melting bath is created under the simultaneous action of at least one laser beam transmitted by optical fiber and at least one gas-protected electric arc generated from a consumable electrode constituting the filler material.

The method according to the invention thus makes it possible very advantageously to maintain a high welding speed of several meters per minute, while using a relatively low laser power, notably less than 4 kW, thanks to the power contributed by the electric arc process. The electric arc welding process is preferably of MIG/MAG type. One can then advantageously have a laser of power delivered on the conduits to be welded of less than or equal to 6 kW, and preferably less than 4 kW, and an MIG torch of power exceeding 8 kW.

The cost of the welding device used for the process of the invention is, moreover, reduced, while the kW produced by the electric arc is markedly less expensive than the kW produced by the laser. The process is, therefore, economically very advantageous, while offering a very rapid welding speed of notably more than 3 m/min.

The process is preferably used with a laser power within the range of 2 to 4 kW, the welding speed obtained then being approximately 2.5 to 4 m/min. The process is then very reliable, economical and less cumbersome, while offering an advantageous welding speed.

The process according to the invention makes it possible to advantageously eliminate the problems that might be associated with the squeeze conditions (alignment of conduits). In fact, if there is daylight at the parting line between the conduits, the laser beam can pass through and the MIG process entering in simultaneous with the laser makes it possible to start the fusion, which could not have taken place if the laser had been alone or if the MIG process had been retarded.

Furthermore, when there is a lack of alignment of the conduits, the MIG process makes it possible to smooth out the penetration profile, while the laser process used alone would in that case have resulted in a stepped penetration profile.

The invention also concerns a welding device for use of the process according to the invention, containing means of generating a laser beam and at least one optical fiber guiding the latter to the parting line between two conduits, the laser beam being merged with the parting line, as well as an electric arc welding torch, such as an MIG torch provided with a consumable electrode and means of distribution of a protective gas, the torch being positioned at an angle from the laser beam, so that the point of impact of the electric arc is close to the focus point of the laser beam in order to create a single melting bath, the gap between the two being called “offset”.

According to one particular embodiment of the process of the invention, in the course of the penetrating pass under the combined action of the laser and the electric arc, the position of the focus point of the laser beam, the gap between the focus point of the laser beam and the position of the point of impact of the electric arc, as well as the angular position of the MIG welding torch relative to the laser beam, can be adjusted independent of each other. The device then advantageously contains means of adjustment of the laser beam in height, means of displacement of the MIG torch for displacing the point of impact of the electric arc and means of angular displacement of the MIG torch.

Thus, that point, gap and angular position were previously defined prior to welding, so that in case of variation of the focus point of the laser beam, a change in the gap between the focus point and the point of impact of the electric arc was induced without being able to remedy the situation, which was not desirable. Furthermore, in the case of orbital displacement of the welding device around the conduits, it is important to modify the angular position of the MIG torch relative to the laser beam in order to define the width of the joint.

The focus point of the laser beam is preferably adjustable in a range of ±5 mm, the gap between the focus point and the point of impact of the electric arc is in the range of 5 mm to +5 mm on both sides of the focus point of the laser and the angular range in which the MIG torch varies in relation to the laser beam is from 5° to 45°.

The possible adjustment of the focus point of the laser beam, of the gap between the focus point and the position of the point of impact and/or of the angular position of the MIG torch enable the variations occurring in the course of the penetration pass owing to the plays and/or alignment defects that might appear at the parting line and owing to the influence of gravity depending on the orbital position around the conduits on the stability of the melting bath to be corrected, in order to return to the optimum welding conditions defined.

One can thus act on the overall penetration capacity of the welding device and on the joint profile so as to improve the assembly.

Thus, preferably, before each welding, set points can be programmed for each of the variables (focus point of the laser beam, gap between the focus point of the laser beam and the point of impact of the electric arc and angular position of the MIG torch), in each of the orbital positions of the welding device around the conduits (the angular position can, notably, be given by a sensor loaded on the welding head).

For that purpose, the device contains means of programming set values and means of recognizing the orbital position of the welding device, such as an angle sensor loaded on the device and means of control of the means of adjustment of the laser beam in height, of the means of displacement of the MIG torch for displacing the point of impact of the electric arc and means of angular displacement of the MIG torch.

As a variant, each of the variables is regulated in real time as a function of information emanating from detection and analysis of the squeeze conditions in real time in the course of the penetrating pass.

According to that particularly advantageous embodiment of the invention, it is possible during orbital welding to more or less concentrate the laser and MIG powers at a single point, which makes it possible to distribute the power density and to notably vary the penetration power, as well as the exterior absorption of the melting bath, with parameters linked to the laser beam and to the constant MIG electric arc.

For that purpose, the device advantageously contains means of detection and analysis of the squeeze conditions in real time in the course of the penetrating pass and means of control in real time of the means of adjustment of the laser beam in height, of the means of displacement of the MIG torch for displacing the point of impact of the electric arc and adjusting the gap between the focus point and the laser beam and point of impact of the electric arc and means of angular displacement of the MIG torch.

That capacity of modification as well as the programming possible as a function of the orbital position or adjustment in real time as a function of the squeeze conditions detected in real time make it possible to guarantee an enhanced quality (compactness), notably on the penetrating pass, as well as for the subsequent overlapping passes.

The invention will now be described more in detail with reference to the attached drawing, in which:

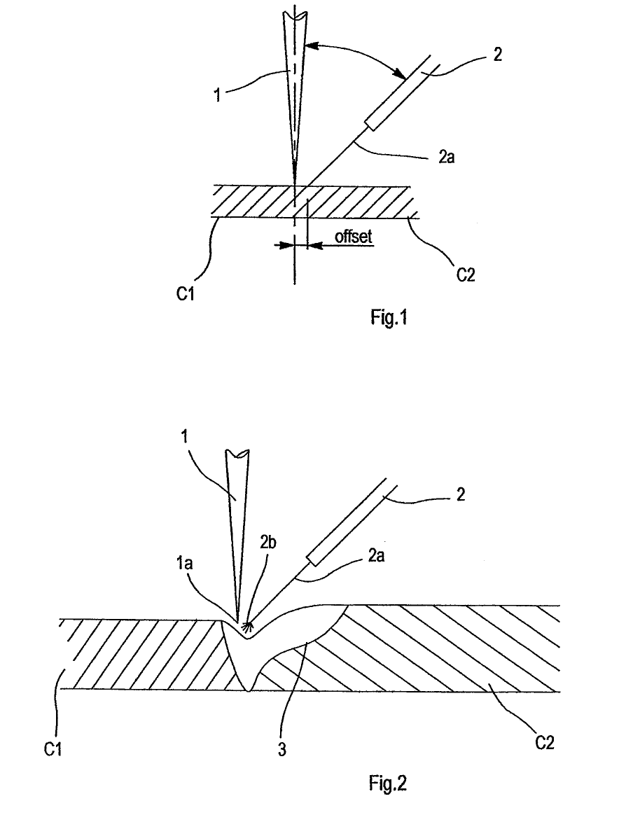

FIG. 1 represents a view in perspective of a welding device according to the invention outside of the welding operation;

FIG. 2 represents a cutaway view in the parting line of a welding device according to the invention in the course of a welding cycle;

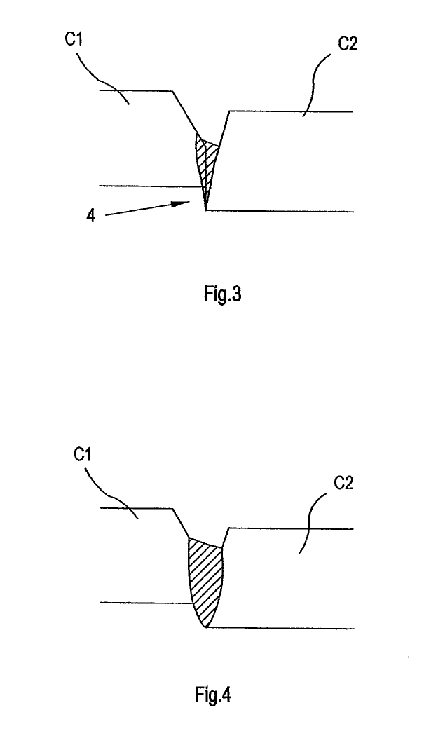

FIG. 3 represents a cutaway view of a melting bath at a bevel on laser welding alone and

FIG. 4 represents a cutaway view similar to FIG. 3, but on a welding operation according to the invention.

As can be seen on FIG. 1, the device according to the invention has at least the means of generating a laser beam 1 and at least an optical fiber guiding the latter to the parting line between two conduits C1 and C2.

The laser beam 1 works roughly perpendicular to the root face of the bevel created between the conduits C₁, C₂. The device further contains an MIG torch 2 provided with a consumable electrode 2a and means of distribution of a protective gas. The torch MIG 2 is angularly positioned in relation to the laser beam 1 at an angle α, so that the point of impact of the electric arc 2b is close to the focus point 1a of the laser beam 1 in order to generate a single melting bath 3, as is visible on FIG. 2.

The gap between the focus point 1a of the laser beam 1 and the electric arc (roughly the end of the consumable electrode 2a) is called “offset”.

The device further contains means of adjustment of the laser beam 1 in height, means of displacement of the MIG torch 2 for displacing the point of impact of the electric arc and means of angular displacement of the MIG torch 2.

The focus point 1a of the laser beam 1 is preferably adjustable in height relative to the bevel root within a range of ±5 mm.

The “offset” gap between the focus point 1a and the point of impact of the electric arc 2b is preferably within the range of −5 mm to +5 mm on both sides of the focus point of the laser 1 and the angular range within which the angle α of the MIG torch varies in relation to the laser beam is 5° to 45°.

The possible adjustment of the focus point of the laser beam, of the gap between the focus point and the position of the point of impact and/or of the angular position of the MIG torch enable the variations occurring in the course of the penetration pass owing to the plays and/or alignment defects that might appear at the parting line and owing to the influence of gravity depending on the orbital position around the conduits on stability of the melting bath to be corrected, in order to return to the optimum welding conditions defined.

Thus, as can be seen on FIG. 3, when a laser device alone is used and there is a misalignment, a step or staircase effect 4 occurs.

On FIG. 4 it can be seen that for a same alignment defect, the welding process according to the invention makes it possible thanks to the generation of a single melting bath to alleviate the step effect 4′.

The invention is not limited to the examples represented, but also covers all the variants coming within the scope of protection defined, notably in the claims.

1. Welding process, particularly for tubular parts, such as metal conduits that are abutted in order to form pipeline type metal pipes, in which the penetrating pass is made on the outside,
characterized in that a single melting bath is created under the simultaneous action of at least one laser beam (1) transmitted by optical fiber and at least one gas-protected electric arc generated from a consumable electrode constituting the filler material.

2. Process according to claim 1,
characterized in that the penetrating pass is made at a laser power delivered on the conduits to be welded of less than or equal to 6 kW and with an electric arc welding torch, such as an MIG torch of power exceeding 8 kW.

3. Process according to one of claims 1 and 2,
characterized in that the position of the focus point of the laser beam (1), the gap between the focus point (1a) of the laser beam (1) and the position of the point of impact (2b) of the electric arc, as well as the angular position of the MIG welding torch relative to the laser beam, are adjusted independent of each other.

4. Process according to claim 3,
characterized in that, before each welding, set points are programmed for each of the variables (focus point of the laser beam, gap between the focus point of the laser beam and the point of impact of the electric arc and the angular position of the MIG torch), in each of the orbital positions of the welding device around the conduits.

5. Process according to claim 3,
characterized in that each of the variables is regulated in real time as a function of the information emanating from detection and analysis of the squeeze conditions in real time in the course of the penetrating pass.

6. Process according to one of claims 3 to 5,
characterized in that the focus point of the laser beam is adjustable within a range of ±5 mm above or below the root of the bevel formed by the two conduits.

7. Process according to one of claims 3 to 6,
characterized in that the gap between the focus point and the point of impact of the electric arc varies within a range of −5 mm to +5 mm on both sides of the focus point of the laser.

8. Process according to one of claims 3 to 7,
characterized in that the angular range (α) within which the MIG torch varies relative to the laser beam is 5° to 45°.

9. Welding device for use of the process according to one of claims 1 to 8, containing at least the means of generating a laser beam (1) and at least an optical fiber guiding the latter to the parting line between two conduits, the laser beam (1) being merged with the parting line (P) created between the conduits (C1, C1), as well as an electric arc welding torch (2), such as an MIG torch (2) provided with a consumable electrode (2a) and means of distribution of a protective gas,
characterized in that the electric arc welding torch (2) is angularly positioned in relation to the laser beam (1), so that the point of impact (2b) of the electric arc is close to the focus point of the laser beam (1) in order to form a single melting bath on the penetrating pass.

10. Device according to claim 9,
characterized in that it contains means of adjustment of the laser beam in height, means of displacement of the MIG torch for displacing the point of impact of the electric arc and means of angular displacement of the MIG torch.

11. Device according to one of claims 9 and 10,
characterized in that it contains means of programming set values and means of recognizing the orbital position of the welding device, such as an angle sensor loaded on the device and means of control of the means of adjustment of the laser beam in height, of the means of displacement of the MIG torch for displacing the point of impact of the electric arc and means of angular displacement of the MIG torch.

12. Device according to one of claims 9 and 10,
characterized in that it contains means of detection and analysis of the squeeze conditions in real time in the course of the penetrating pass and means of control in real time of the means of adjustment of the laser beam in height, of the means of displacement of the MIG torch for displacing the point of impact of the electric arc and means of angular displacement of the MIG torch.
